(19) United States
(12) Patent Application Publication
(10) Pub. No.: US 2014/0162243 A1
(43) Pub. Date: Jun. 12, 2014

(54) Method for Creating and Displaying Content

(71) Applicant: Kathleen Marie Lamkin, San Diego, CA (US)

(72) Inventor: Kathleen Marie Lamkin, San Diego, CA (US)

(21) Appl. No.: 14/067,362

(22) Filed: Oct. 30, 2013

Related U.S. Application Data
(60) Provisional application No. 61/720,371, filed on Oct. 30, 2012.

(51) Int. Cl. G09B 5/00

(52) U.S. Cl. CPC G09B 5/00
USPC 434/365

(57) ABSTRACT

The present specification discloses a method of creating and presenting one or more versions of content derived from an original content. The method includes obtaining the original content, obtaining an identifier of the original content; defining one or more subsets of the original content, saving the defined subsets as different versions of content, and presenting one or more of the saved versions of content.

### CROSS REFERENCE

The present specification relies on U.S. Provisional Patent Application No. 61/720,371, filed on Oct. 30, 2012, which is incorporated herein by reference in its entirety.

### FIELD OF THE INVENTION

The present specification relates generally to the display of digital content. More particularly, the present specification describes a method of displaying, presenting, filtering, modifying, highlighting and tagging digital content for enhancing a user's content learning experience.

### BACKGROUND

Over the last several decades, there has been an increase in content distribution, including multimedia content, text, images, video and other such content. There are a number of different formats available for distributing content as well as a number of different forms of media upon which content may be stored and then displayed. Further, over the last few decades the digital format has become the preferred method of storing content.

Large amounts of digital data may be stored on various mediums including hard disks, solid state devices (SSD), flash-based devices, tape and portable storage mediums such as CDs, DVDs, Blu-ray discs, etc. Numerous applications are available for providing enhanced navigation or interaction with the content stored on digital media. Such navigation allows a user to interact with the content by locating desired content and obtaining an enhanced presentation of the content.

Presently, there has been an increase in the number of students preferring to study via digital content. As a result, a large number of students are using digital devices to view and learn academic content. Further, tablet devices and computers are becoming the preferred medium for taking study notes by students from class lectures or from books and other course material.

There are many eReaders and tablet devices, currently available on the market, that provide for interaction with digital content. Various available smart tablet and handset devices such as the Apple's iOS-based iPad and iPhones and Android-based tablets and handsets such as Amazon's Kindle or Barnes and Nobles' NOOK run applications, such as Apple's iBook, Amazon's Kindle or Barnes and Noble NOOK reading applications that support pre-authored interactive text books. However, such devices offer limited functionality for preparing study notes or learning material such as flash cards and offer only simplistic studying techniques. The flash card generating capability of available devices is limited to glossary terms or character recognition, or the generation of flash cards based on single highlighted information from a specified text without specifying a front and back to a flash card, for studying, or allowing for further customization. Presently available devices do not support older electronic books also known as eBooks, generic Internet information, or even books or documents containing only pictures. Further these interactive eBooks require preauthoring by the original book author and do not allow for adding or modifying presentation of the content after it has been published and distributed to the user.

Hence, there is need for a method and system which provide users with enhanced studying and learning capabilities. In addition, what is needed is a method for displaying, presenting, filtering, modifying, highlighting and tagging content for learning and presentation.

### SUMMARY

In one embodiment, the present specification describes a method for creating and presenting one or more versions of content derived from original content, the method comprising the steps of: obtaining the original content; obtaining an identifier of the original content; defining one or more subsets of the original content; saving the defined subsets as different related or views of versions of content; and presenting one or more of the saved versions of content.

In another embodiment, the method of creating and presenting one or more versions of content further comprises the steps of: scoring each presentation of each version of content based on a user's performance in learning the versions of content; generating a final score corresponding to one or more versions of content based on the score of each presentation; re-presenting the versions of content based on the final score and the scores of each version of content; and presenting trending graphics indicating the user's performance over a predetermined number of iterations and time.

In an embodiment, the original content comprises study material, textbooks, notes, hand-outs, published materials, and multimedia content. In one embodiment, the identifier for the original content is obtained by using a hash algorithm.

In one embodiment, a subset of the original content is defined by using filters and/or overlays. In another embodiment, a subset is defined by defining a version of the original content relating to the original content. In another embodiment a subset is defined by indicating a first portion of the original content and then indicating a second portion of the original content related to the first portion. In one embodiment, a subset of original content is defined by using overlays to cover one or more portions of the original content when the original content comprises a picture, the overlays being displayed in a presentation mode, the overlays being removable by a user. In another embodiment, a subset of an original content is defined by using one or more overlays to cover one or more portions of the original content, the overlays being available in a plurality of editable shapes.

In an embodiment, the step of defining one or more subsets comprises prompting a user to select a predefined mode from among a plurality of available modes of displaying content. In another embodiment, a user is prompted to rate each version of content, the ratings being stored. In another embodiment, the step of defining a subset of the original content comprises creating one or more flashcards based on the original content, each flash card having a first side comprising a question and a second side comprising a solution to the question, the second side being revealed to a user in a presentation mode upon receiving a prompt for the same from the user. The solution may be a word or words, a correct answer to the question being asked, or be a drawing to replicate a covered up area. In yet another embodiment, the step of defining a subset of the original content comprises annotating sections or pages of the original content in order of importance. In yet another embodiment, the step of defining a subset of the original content may require modifying the content through a group of overlays or reordering of the content. Further the modifying could include simplifying or replacing aspects of the content with new content.

In another embodiment, saved versions of content are shared among a plurality of users over a network. In another embodiment the scores of the users are shared amount a plurality of users over a network. In another embodiment, the scores are aggregated to determine which material is most often scored the lowest. In another embodiment, the scores are further used in the weighting of the presentation of the question for better learning of the difficult material or in the overall estimation of the amount left to learn.

In an embodiment, presenting a version of content comprises prompting a user to provide a solution to one or more problems posed in the version of content. In another embodiment, presenting a version of content comprises prompting a user to provide a solution for uncovering one or more overlaid portions of the version of content. In another embodiment, scoring each presentation comprises prompting a user to indicate a success or a failure corresponding to one or more problems posed in the presented version of content, a score being obtained by summing the number of successes indicated corresponding to the version of content.

In an embodiment the display of the content can be across multiple devices. The original content may be displayed on a primary device while the secondary content is displayed on a secondary device. In an embodiment the primary device may be a computer while the secondary device may be a mobile or tablet device. Further communication between the devices may exist fo allow for the display of the content on the secondary device in sync with the current page or content that is being displayed on the primary device. Therefore if a user changes the page of the primary device then the associated content on that page will also display on the secondary device. The communication is not limited to local networks, Wi-Fi, Bluetooth, and Zigbee or any other method may be used for communication.

The aforementioned and other embodiments of the present shall be described in greater depth in the drawings and detailed description provided below.

### BRIEF DESCRIPTION OF THE DRAWINGS

These and other features and advantages of the present invention will be further appreciated, as they become better understood by reference to the detailed description when considered in connection with the accompanying drawings:

FIG. 1 illustrates a flowchart depicting a method of creating and presenting content for studying, in accordance with an embodiment of the present invention;

FIG. 2A illustrates an exemplary content interaction page, in accordance with an embodiment of the present invention;

FIG. 2B illustrates another exemplary content interaction page, in accordance with an embodiment of the present invention;

FIG. 2C illustrates a method of resizing a shape for creating an overlay, in accordance with an embodiment of the present invention;

FIG. 3 illustrates an exemplary content presentation page containing a math problem, in accordance with an embodiment of the present invention;

FIG. 4 illustrates an exemplary set of flash cards generated in accordance with an embodiment of the present invention;

FIG. 5 illustrates a picture that may be studied in a plurality of modes, in accordance with an embodiment of the present invention; and

FIG. 6 is a block diagram illustrating exemplary system modules for creating and presenting content for interactive learning, in accordance with an embodiment of the present invention.

### DETAILED DESCRIPTION

In various embodiments, the present specification describes methods and systems for use in creating and presenting content for studying and learning in an interactive manner. The method of the present specification enables users to reference and display digital content along with creating relations between subsets of the content. The present specification provides a method of relating content among text, images, video, digital books, notes, and study aids for better consumption and learning of the content. The present specification also discloses a method of creation of overlays used in presenting and filtering the content during playback.

The present specification discloses multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

It should be appreciated that each of the steps disclosed herein are performed by a computing device, such as a laptop, mobile phone, tablet, personal computer, or other electronic device, executing a plurality of programmatic instructions. The instructions may be stored locally on the computing device or may be stored on a server and selectively executed when actuated by a user interacting with an interface on the computing device, i.e. clicking on a button or icon. Each of the steps disclosed below can be executed either locally, on the computing device, or remotely, on one or more servers.

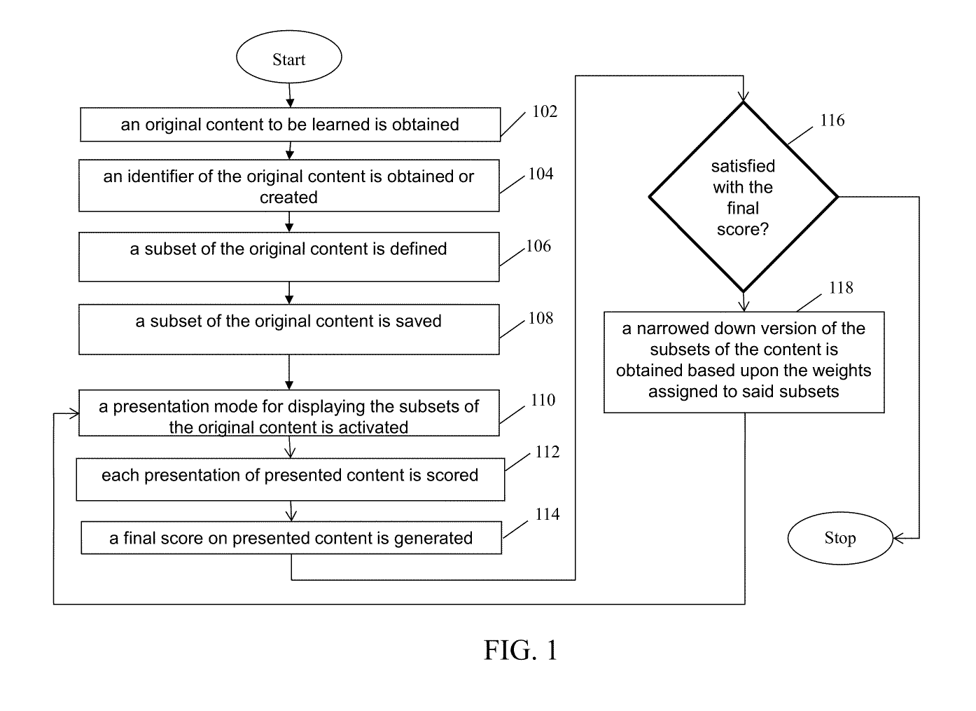

FIG. 1 illustrates a flowchart depicting a method of creating and presenting content for studying and interactive learning, in accordance with an embodiment of the present invention. At step 102 original content for learning is accessed, obtained and/or defined. In various embodiments, the original content maybe any study material including textbooks, notes, handouts, published materials, multimedia content including text, graphics, images, or video etc. The method of the present invention allows for the original content to be utilized without having to prepare or adapt the content material being studied in any manner. In addition, the supplemental study content can be generated at a later time by a future consumer, reader, student or teacher, and is typically not generated by the original author.

At step 104, an identifier of the original content is obtained or created. In an embodiment, the original content is assigned a reference identifier (ID) by a program on the computing device or a server. In another embodiment, a content ID is obtained from a central electronic repository located remotely from the client. For example, where original content is obtained or derived from a book an International Standard Book Number (ISBN), a Standard Book Number (SBN), an Online Computer Library Center (OCLC) number, which is the unique number assigned to a book by the OCLC when the book's record is added to the WorldCat cataloging system, and/or the Library of Congress Control Number (LCCN) may be used as the identifier (ID) while for digital media, the International Standard Audiovisual Number (ISAN) numbers or IDs obtained from databases such as Enterainment Identifier Registry (EIDR), All Music Guide (AMG), Internet Movie Database (IMDb), may be used as the identifier. In an embodiment, a secondary ID for original content is generated through a hash algorithm, such as the MD5 Message-Digest Algorithm or SHA-1, SHA-2, SHA-3 cyptographic hash functions, on a content or graphical page. The secondary ID can be used for the content as the primary ID if no alternative ID exists. The text of the document can be utilized by the hash algorithm to create a unique identifier for later use. A secondary ID is created or obtained corresponding to each original content such that the content may be associated to a secondary study material created in accordance with the present specification. This allows for the created secondary study material to be posted online to a central repository and then referenced back for others to use and to share. Further a sub-identifier of the content may be used to indicate a particular section of the content such as a page number or virtual page number based on the number of words or an offset into the content/text, such as the location or x,y coordinate for a given page or an index such as a figure number.

In another embodiment, a hash function may be generated for each line of text, for a variable number of words, for example ranging from 10 to 100, or a variable number of sentences. Where a hash function is generated for a group of words, the words include enough characters to uniquely distinguish the group from other groups of words within the same content, to allow for unique positioning information providing a relative offset as to which word within a hashed set of words is the starting point of a desired tag, overlay, or associated content.

In an embodiment, the identifier corresponds to a particular subject matter or class. For example the identifier may identify classes such as Physics 101, Chemistry 2B, Spanish 3, Multivariable Calculus, or Linear Algebra at a University, or Advanced Placement European History, Physic, Biology, Geometry and may also identify if the class is an honours or advanced placement class of a particular subject. Further, the identifier may include identifying information regarding the level or grade the content was intended for. In another embodiment, the content identifier may also include identifying information regarding a particular institution or school in which that the class has been taken for the creation of the content. Further, the content identifier may include identifying information regarding the teacher or professor that taught the class.

At step 106, one or more subsets of the original content are defined. In various embodiments, the subset is defined through the creation of filters or overlays. A filter is any variable, defined by a plurality of programmatic instructions or functions, which, if defined, will functionally exclude certain of the original content from a subset and will functionally include certain of the original content within the subset. An overlay is any mechanism, defined by a plurality of programmatic instructions or functions, which will functionally highlight, or render opaque, certain of the original content to thereby identify it as being part of, or not being a part of, a subset. In an embodiment, a subset is defined by indicating a first set of content that is to be studied, and subsequently, a second set of content that relates to the first set of content. For example, in one embodiment, the first set of content may be a set of words in a textbook, while the second set of content may be the definitions that correspond to that set of words.

In another embodiment, a subset may include a list in two columns, with a first set of words or numbers in a first column and a result in a second column. For example, in the case of presenting information related to learning United States presidents and their respective dates in office, subsets may be formed by defining a first area or set of words as the dates in office, presented in a first column, while defining a second area or set of words as the presidents who served during those dates, presented in a second column. The method of the present invention allows for effective learning the content presented in the columns in a plurality of randomized orders, or predefined orders, which, in the example, are the dates in office and the names of the presidents who served during those dates. Material may be presented both forwards and backwards. For example, a word may be presented wherein a definition is asked for or a definition is presented, requesting the word that corresponds to that definition. Subsequent presentation iterations may include the same order or a randomized order based on the user selection. For example, in one embodiment, the user may make a randomization request by shaking the device whereby the device's accelerometer senses the input made by the user and notifies the application for processing. Further the application may use this action to randomize the order of presentation and present the content in a different order again to the user.

At step 108, the subsets are saved for individual use or for sharing with other users. In an embodiment, the created overlays may be shared over the Internet, or for example, be released at time intervals based on the material being shown in a lecture or class. Further, near-field communication standards may be utilized in conjunction with the method of the present invention in order to share content. Further, content may be shared via Peer to Peer exchange of notes from device to device. This may include the user of near-field communication (NFC), which is a set of standards for smartphones and similar devices to establish radio communication by touching them together or placing them in relative proximity to each other. This may also include use of technology similar to radio-frequency identification (RFID). Additional technologies that may be used with the method of the present invention for content sharing include, but are not limited to local networks, Wi-Fi, Bluetooth, Zigbee, AirDrop used by Apple products which utilizes peer to peer file sharing over Wi-Fi networks, cellular networks such as 3G, 4G, LTE, among others. The exchange of notes may also include the transfer of the associated license or rights to the additional content in the event the additional content was previously purchased or restricted. For a license that was purchased for a specific amount of time with an expiration date, the transferred license may maintain the same expiration date so the new user will only be entitled to the content for this remaining amount of time. The amount of time of the license could vary for 12 hours for studying the night before a test to the length of the course for quarter, semester or year, to the length in college or even forever in time. In some embodiments, this transfer of the license may require an additional fee paid by the recipient in order to transfer the license. In an embodiment, the recipient of the content may need to pay a transaction fee to the user selling the content, but in addition, a fee may also need to be paid to the original content provider, such as the book publisher as reimbursement for the redistribution of the content to another user. In some embodiments, the length of the license may be based on the contribution of additional material submitted by the user and redeeming credit to purchase additional material.

At step 110, a presentation mode for displaying subsets of the original content is activated. In various embodiments of the present invention, the creation of subsets and overlays may also be applied to images and figures. For example, many images require learning of one or more labeled parts. The method of the present invention, by using overlays to cover up areas of study and requiring the user to provide answers or fill in the covered areas, is employed to facilitate the study or interactive learning of such images. In an embodiment, each overlay further includes a number that is displayed with transparency to represent the covered area. Further, each overlay can then be lifted in a random order to display the respective answers after they are presented to the user. In an embodiment, after an image is uncovered, it may either be left uncovered or again be covered, and the next image may be displayed in the event that the overlay overlaps another area or that it would give a hint to what the next answer is.

In an embodiment, the answers may be entered on any device implementing the method of the present invention. The entered answers are compared against a list of correct answers by an application running on the device, which then also presents a score to the user, based on the result of the comparison. In another embodiment, the image with the overlays may be used by the user for mentally recalling the required answers (flashcard scenario), or writing down the answers on a separate sheet of paper and then comparing the same with a correct set of answers. In yet another embodiment, areas within a page of the content may be defined, for example, by adding a defining box around an entire figure so that the figure may be separated and presented separate from the rest of the content on the page.

In an embodiment, the method of the present invention may be used for learning mathematics problems from a book. An overlay may be used for hiding the answers that are next to the problems so that the answers may be revealed when desired. This eliminates the need to have answers to the problems to be provided at the back of the textbook. In an embodiment, a password may be set, which would be required for unlocking the answers, thereby preventing a student from looking at the answers before a time specified by a teacher. This method thereby allows both a student and a teacher to utilize the same book without requiring two different electronic editions of the same. Further, a plurality of different passwords may be utilized to unlock different sets of material in a given content. In an embodiment, the version of the content purchased may provide a license for display of a limited portion of content or a license for display of all of the content. Thus, for example, the method of the present invention allows both a student edition of a book and a teacher edition of the same book to be purchased, with a license being made available as part of the transaction to unlock the respective content based on the license. Further, in an embodiment, the unlocking of the answers may be controlled based on time elapsed, such that the answers are only displayed for example, only after a homework due date has elapsed. In another embodiment, the unlocking of the content may be controlled by a teacher or by the execution of a specific action. For example, the teacher or a website may detect that a student has turned in the homework and may be allowed to see the answers which are thus unlocked for display. Further, the method of the present invention may be used in a testing scenario where the teacher supervises a test taken from a book and then having the answers displayed after the test finishes.

In another embodiment, the method of the present invention may be used to study multiple levels of an equation, multiple steps in a solution or any content that requires multiple levels of study. In this embodiment each step or level may be revealed separately and be learned and graded individually. This enables efficient learning of each of the steps of the content.

In another embodiment, the method of the present invention may be used to study a picture or a diagram with labeled parts. The present invention enables hiding the labels by using overlays, providing answers corresponding to the hidden labels, and then checking for a correct answer.

Further, in an embodiment, the method of the present invention enables creation of a quiz by creating flash cards for learning subjects involving a plurality of “questions” with a corresponding plurality of “answers”. In one embodiment, for example, the “questions” comprise word meanings or while the “answers” comprise word definitions, or the reverse. The content in the form of a quiz or flash cards may then be shuffled and presented to a user in a random order. The user may either be prompted to enter a correct answer into the device running the method of the present invention, or may provide oral answers.

In another embodiment, the method of the present invention utilizes a timer for displaying the content to the user. The length of time to respond to the question is further utilized as a weight for the confidence of the answer for later presenting the material in a subsequent iteration. This length of time is then used to determine the estimated time till all of the material will be learned.

At step 112, each instance of presented content is scored, meaning that the user receives a score for their interaction with the system each time. In one embodiment, once the overlaid content is presented to a user for learning purpose, and after making an indication of a mental note of the correct or incorrect result, the user may view the corresponding answer and indicate success or failure through a prompt (manual self-scoring). In another embodiment, the scoring process is automated such that upon actual input of a response, the device will automatically generate a score of success or failure (automated scoring).

At step 114, a final score on presented content (either via automated or manual scoring) is generated. In an embodiment, the method of the present invention provides for tallying a cumulative score and enabling a user to view the answers that were incorrect. A cumulative score is kept to allow later viewing of only those questions that were answered incorrectly. In an embodiment a grading scale ranging from, for example, 1 to 10 may be presented to the user along with the overlaid content prompting the user to assign a weight to each entered answer depending upon the user's confidence in the answer. In an embodiment, the method of the present invention enables assigning weight to a subset of original content defining what still needs to be learned, or should be studied at a later iteration of presenting the content. In another embodiment, a length of time taken to respond to a question is used to weight each answer and determine the user's score. In another embodiment, the scores of the users are shared among a plurality of users over a network. In another embodiment, the scores are aggregated to determine which content most often corresponds to lower scores. In another embodiment, the average scores of a plurality of users are used for the weighting the an individual user's answers to determine the overall score.

At step 116, it is determined if a user is satisfied with the final score. If the user is not satisfied with the final score, then at step 118 a narrowed down version of the subset(s) of content is obtained based upon the weights assigned to said subsets and steps 110 to 116 are repeated. In an embodiment, step 118 comprises presenting graphs including trending graphics that indicate how the content is being learned by the user over a predetermined number of iterations and time. The graphics or graphs may include number of questions answered correctly, number of questions answered incorrectly, a percentage of each, based on the total questions presented, or a ratio of each. In another embodiment the graphs may include a weight of how well the question was answered if a scale of how well the user knows a given answer is given for each question. Further the length of time required to answer each question can be used as a weight of how well an answer is know for a given question to further present the trend and for a measure of learning. The length of time that the material is studied can also be tracked and an estimate can be made for the amount of time that future iterations will take to learn the material. Each iteration should be stored in a current state so that the user can stop the process and resume at a later time. In an embodiment, the user's score can be compared to other users' who have shared their scores over a network or the Internet. In an embodiment, the average time taken by other users to learn the content or the average number of iterations required can be displayed to the user. This enables the user to estimate the amount of time required to be allocated on an average to learn the content. Additional statistics such as the minimum, maximum, median, and percentiles of the time required to learn the content may be also be presented. Hence, the method of the present invention ensures that the user allocates an adequate amount of time to learn the content. In an embodiment, the time taken by a user to learn the material may be compared with the time taken by other users for learning the same content. The percentage difference across different content within the same subject area can be calculated and then be used to improve the estimates to learn further content within the same subject area.

Often times individuals learn different subjects at different rates so it is important to categorize the content into subjects such as math, science, history, English, music, or into more specific areas such as biology, chemistry, and physics. In addition, the difference in a particular user's learning behaviour may be compared across all subjects with the learning behavior of a plurality of users to determine an overall intelligence factor or be used to determine how well the content is learned overall. In another embodiment, the submitted scores for a given order of the presentation of content may be used to find the presentation order of the content that results in the lowest time to learn. For example, if a user is learning the presidents of the United States the learning scores could show that if the presidents are presented in the order that they came into office starting with the first president results in a faster time to learn.

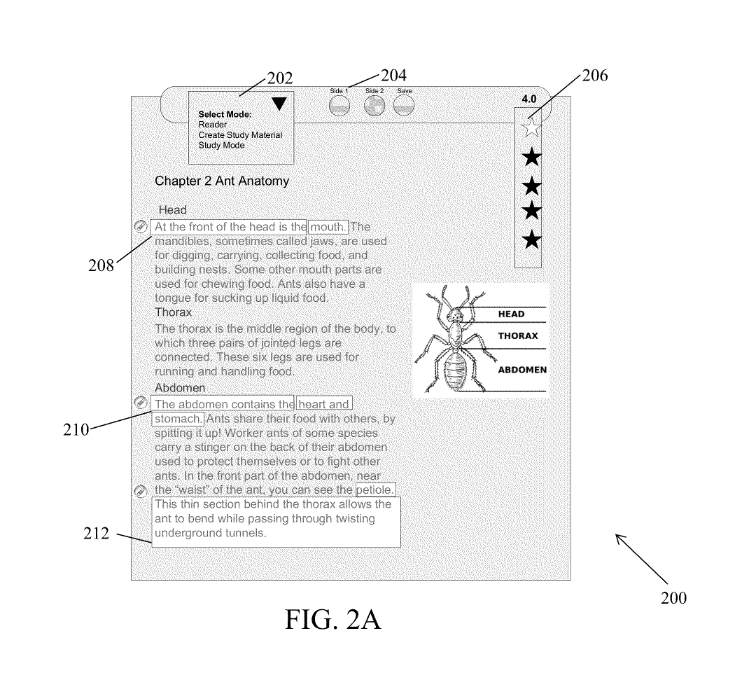

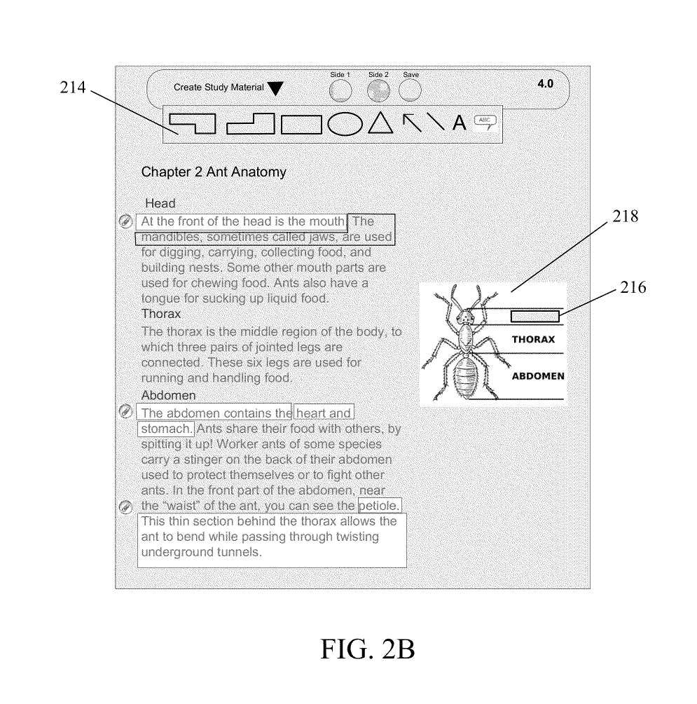

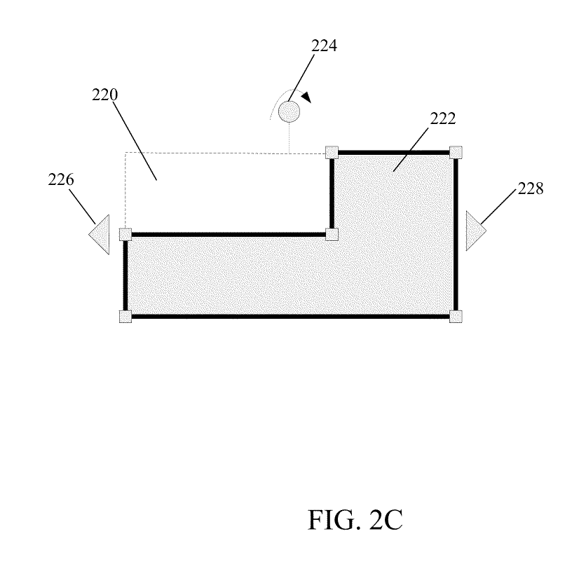

FIG. 2A illustrates an exemplary content interaction page, in accordance with an embodiment of the present invention. The page 200 comprises a section 202 for presenting a plurality of selection modes such as a ‘reader’ mode for enabling a user to read content, a ‘create study material’ mode enabling a user to define subsets of content, and a ‘study’ or presentation mode allowing a user to learn by studying presentations of the created subsets of content. The page 200 comprises a section 204 comprising a plurality of selectable options such as ‘side 1’, ‘side 2’, and ‘save’. During the content creation process the user can select a section of text and indicate whether it is ‘side 1’ or ‘side 2’ for the flash card and then make a second selection of text and indicate the opposite side of the card not originally indicated. Finally the last step may be to save the selection or flash card created. The page 200 further comprises a section 206 allowing a user to rate the content on the page by using a plurality of selectable stars where a single star denotes content of least importance and five stars denote content of maximum importance. This could be used for a given page or for individual flash cards or pairs that are created. If the ‘create study material’ mode from section 202 is selected, the present invention enables a user to define subsets of the content on page 202. The user may create subsets by selecting various sections 208, 210, 212 of the content. The selected content 208, 210, 212 is hidden by overlays in a ‘study’ mode. The content may also be displayed on the original page but with overlays that may hide or expose the material. Some users recall material based on the original position on the page and therefore using overlays on the original page can improve their learning. In an embodiment, the text within the content that is selected may be readable by the application character by character for easy storage.

FIG. 2B illustrates an exemplary content interaction page, in accordance with an embodiment of the present invention. When a ‘create study material’ mode from section 202 is selected a plurality of options for creating overlays on the content of page 200 are presented in section 214. The options comprise a plurality of shapes which if selected would create overlays of corresponding shapes on the content, the option of adding a text to the content and the option of adding a comment on the page 200. A user may also create an overlay 216 on a labeled part of a picture 218 on the page 200. A bounding box for a given figure may also be indicated to capture a subset of an image or the entire figure as the first area of indication.

FIG. 2C illustrates a method of resizing a shape for creating an overlay, in accordance with an embodiment of the present invention. A rectangular overlay shape 220 selected from section 214 of the page 200, may be resized to form a shape 222 before being used to overlay content on page 200. Further a section 224 may be used to rotate the shape 222. Arrows 226 and 228 may be used respectively for navigating to a previous or a next shape illustrated in section 214. In various embodiments, in the case of the creation of overlays for graphics, any of a plurality of predefined shapes may be used as overlay on pictures, charts, or images for covering up content. Overlays may also be resized, flipped, rotated, etc. Further two overlays may be combined or grouped, for example, a triangular shape and a rectangular shape may be combined to form a new shape to cover up a section of a diagram; multiple rectangular shapes may be combined for covering up areas at a top, bottom and middle of a picture. In various embodiments, an overlay may have multiple layers of overlays. Overlays may be used at a plurality of different levels such as an overlay for defining an original text, an overlay for defining a teacher's indications, an overlay for defining a student's indications, an overlay for defining content that has not yet been learned, etc.

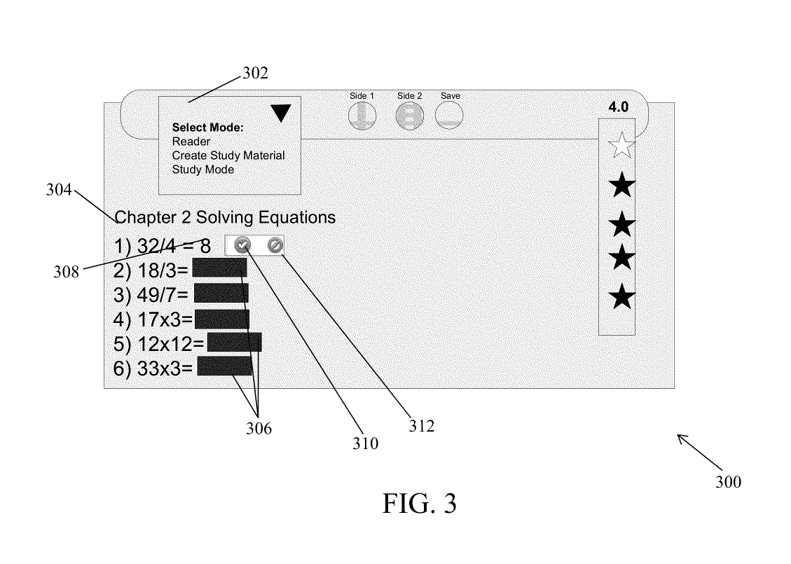

FIG. 3 illustrates an exemplary content presentation page containing a math problem, in accordance with an embodiment of the present invention. A content presentation page 300 displayed upon selection of a ‘study’ mode from a section 302, comprises a section 304 containing a plurality of math problems. In ‘study’ mode, answers to the problems are covered with overlays 306. A user may answer a problem and choose to remove an overlay via a finger gesture, swipe or onscreen button, or timer to reveal a correct answer 308 to the problem from underneath the removed overlay. In an embodiment, the user is provided with an option to mark each revealed answer by choosing either a green tick mark 310 or a red wrong sign 312. The mark 310 or 312 would enable representation of subsets of content for learning to the user at a later time, for example just those that were given incorrect answers. In an embodiment, the overlays may be the same color as the background of the page so that the user does not know that they are even present on the page. In another embodiment, a user may be required to provide an unlock code for making the overlays be visible to the user.

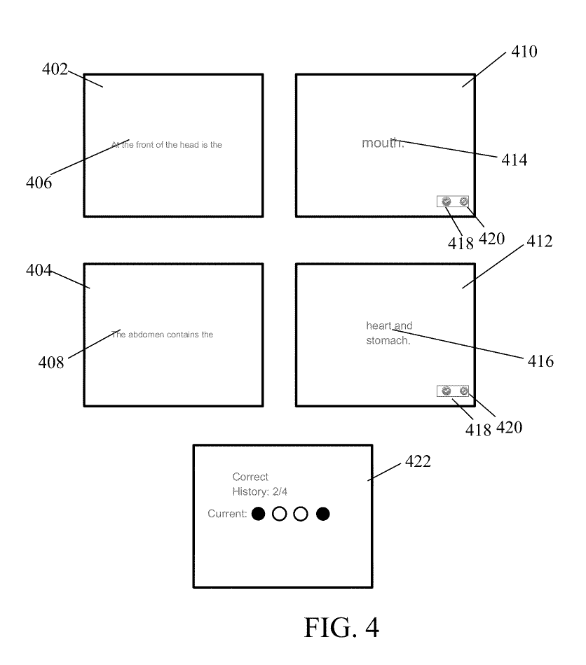

FIG. 4 illustrates an exemplary set of flash cards generated in accordance with an embodiment of the present invention. Each flash card comprises a first side 402, 404 comprising a question 406, 408; and a second side 410, 412 comprising an answer 414, 416 to the questions presented on the first sides 402, and 404 respectively. A user viewing a question 406 or 408 may provide an answer and then overturn the flash card to see a correct answer 414 or 416 respectively. In an embodiment, the user is provided with an option to mark each revealed answer by choosing either a green tick mark 418 or a red wrong sign 420. The mark 418 or 420 would enable presentation of a score 422 of the user. In another embodiment, the scored response may utilize a numbering system from 1 to 10 to indicate the confidence of the answer. In another embodiment, if the answer is partially correct, an intermediate scoring value may be provided. In an embodiment the score 422 comprises a pictorial representation of the number of questions attempted and the number of correct answers provided. In another embodiment the user may also assign a name or title to each flash card to summarize it and/or indicate the applicable topic etc. This can be used by a user to later pick or filter a set of cards for a particular purpose. As an example, a set of cards could be labeled a pertaining to Chapter 3 and another set simply labeled as pertaining to Chapter 4. In another example, a set of cards can be labeled as associated with the page number from which the content was taken.

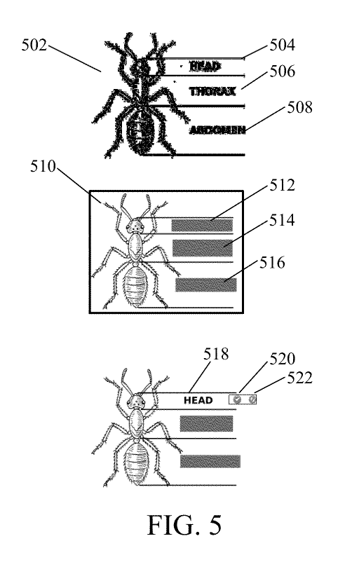

FIG. 5 illustrates a picture that may be studied in a plurality of modes, in accordance with an embodiment of the present invention. Section 502 depicts a picture being studied in a ‘reader’ mode where the entire picture with all labeled parts is visible. Labels ‘head’ 504, ‘thorax’ 506, and ‘abdomen 508 are visible to a user in the ‘reader’ mode. Upon selection of a ‘study’ mode the labeled parts of the picture 504, 506 and 508 are covered with overlays 512, 514 and 516 respectively as illustrated in section 510. A user may provide an answer with respect to a given overlay such as 512 and then remove the overlay to reveal a correct answer 518 from beneath the overlay. In an embodiment, the user is provided with an option to mark each revealed answer by choosing either a green tick mark 520 or a red wrong sign 522. The mark 520 or 522 would enable presentation of a score of the user.

In various embodiments of the present invention a relative recognition method is used, thereby allowing the same set of overlays to be used in both older and newer versions of a book or content. While some material is created from original text, flash cards can be used independently of the relative position of the text as material may change from one chapter to another from one version to another. For new versions of a book the same overlays that were created for an old version may be applied through relative recognition of characters, figure naming etc. Using a content hierarchy to track content relationships allows subsequent versions of say a textbook to be used with the same associated content but different tag locations within the later version of content so the same content can be used with later versions of the book.

Each associated content location requires a content anchor to indicate where, within the original content, an overlay is to be used or supplemental content is associated with. This could be derived, for example, by applying a hash algorithm to the characters in each sentence of the content to form a fingerprint for each sentence and consecutive fingerprints can be used to determine a location or area within a book. Even though some text changes may have occurred in a future version a majority of the sentence finger prints will match from version to version thus allowing relative positions to be determined for those that match. In another embodiment, a comparison of content or textual sentences can be performed, thus finding the common sections and differences and subsequently creating a conversion between a previous version and a new version of content through a mapping table. In another embodiment, a hash function may be generated for each line of text, for a variable number of words, for example ranging from 10 to 100; or a variable number of sentences. Where a hash function is generated for a group of words, the words include enough characters to uniquely distinguish the group from other groups of words within the same content, to allow for unique positioning information providing a relative offset as to which word within a hashed set of words is the starting point of a desired tag, overlay, or associated content. Many eBook formats have separate call-outs for figures that allow individual figures to be finger printed with a hash algorithm or through the associated figure captions. In an embodiment, Extensible Markup Language (XML), which is a markup language that defines a set of rules, content anchors or tags can be used for the association of the content based e-book formats.

In the case of graphical overlays, a content anchor may be a relative X/Y coordinate on a given page number indicating relative overlay positions within a given figure. In case of the original content being in a character recognizable form, various available character recognition techniques may be used in place of a content anchor. Notes in a column that were previously created can be exchanged with others with different editions through the use of finding the differences and anchoring notes in a column to adjacent text. Newer versions of eBooks and even documents such as those in Microsoft Word format utilize Extensible Markup Language (XML), which is a markup language that defines a set of rules and includes formatting along with the textual information and reference to images or video. Other formats may utilize Hyper Text Markup Langauage (HTML) or Content Style Sheets (CSS) or the Portable Document Format (PDF). Regardless of the format, the formats allow for the parsing of the text, images and associated formatting to allow for the determining of relative positions from one version to another. Finally, if through various means, a content anchor tag position cannot be located a means to prompt a user for specifying a page and tagging the text again through the aid of word searches or manual specification may be required by a user.

Similarly, the format of the supplemental, additional content, or content overlays, etc. can further be defined using Extensible Markup Language (XML), which is a markup language that defines a set of rules, content anchors or tags for the association of the content and includes formatting along with the textual information and overlaps of predefined shapes as overlays. Additional content may also utilize Hyper Text Markup Langauage (HTML) or Content Style Sheets (CSS) for the material.

While studying, users typically tend to highlight or underline content of importance with different colors, the present invention provides a method of marking content of importance using “stars” or ratings. In an embodiment, a user may also be enabled to use numbers to annotate sections or pages of content in order of importance. In an embodiment, the importance of a section of content may also be indicated by switching colors for highlighting content; a darker or a brighter color being used for highlighting more important content.

In another embodiment, the method of the present invention enables users to use finger strokes or gestures for annotating content. For example, highlighting or underlining a word by using a finger followed by a question mark stroke also made by using a finger, causes a dictionary and/or thesaurus to show the definition/synonym of the highlighted/underlined word. Further, in various embodiments, the present invention allows users to select content in a plurality of ways known in the art, such as by using two fingers and then dragging the ends. Such selection methods used in conjunction with defining a first and a second set of associated content leads to creation of study material.

In an embodiment, the method of the present invention may be used in conjunction with an e-commerce system developed for the selling of associated content for a given book. In an embodiment, additional content may be purchased at the time of buying the original content as part of the same transaction or else at a later time in a subsequent transaction. In another embodiment, a rental or licensing model allowing the rental or licensing of books to students/users may be used in conjunction with the method of the present invention. The rental model may allow lending and borrowing of a plurality of users' notes and associated content along with markups to electronic books. When receiving content contributed by an unknown user, the accuracy of the received content may be monitored and maintained by using a public rating system, in which, if a predefined number of people comment negatively regarding the quality of an associated content, the content is removed from circulation. In other embodiments instead of purchasing an entire book an individual chapter may be licensed at a prorated price. In an embodiment, the rental period may also be determined for a predefined period of time, for example, for a specific number of months, for the length of a class, or even for an hour. Further the additional content may be available as a subscription service. Users may gain access to such content through a monthly fee that entitles them to all or a pre-defined portion/category of the content. In an embodiment, the additional content and study aids may also include promotional advertisements to help supplement the cost or fee for the content. These advertisements may be placed in the margins of the reading material or displayed with, fancy boxes, bubbles or pop-ups. In another embodiment, during the presentation of the study material, for example between flash cards or at the end of each iteration of presentation of the material for study an advertisement may be displayed. These advertisements can include presenting other supplemental content, additional study aids, related websites, or premium content, for example showing an advertisement for the Spark Notes or Cliff Notes for a given book that is available for sale or currently being studied.

In an embodiment, the method of the present invention may be used in conjunction with known products such as Spark Notes and Cliff Notes that summarize a book. The combination of the present invention with such applications may be used to enhance learning from a summarized version of a book by linking a summarized content to an original content and vice versa. The combination may also facilitate creation of quick quizzes based on highlighted content, with fill in the blank, vocabulary/definition etc.

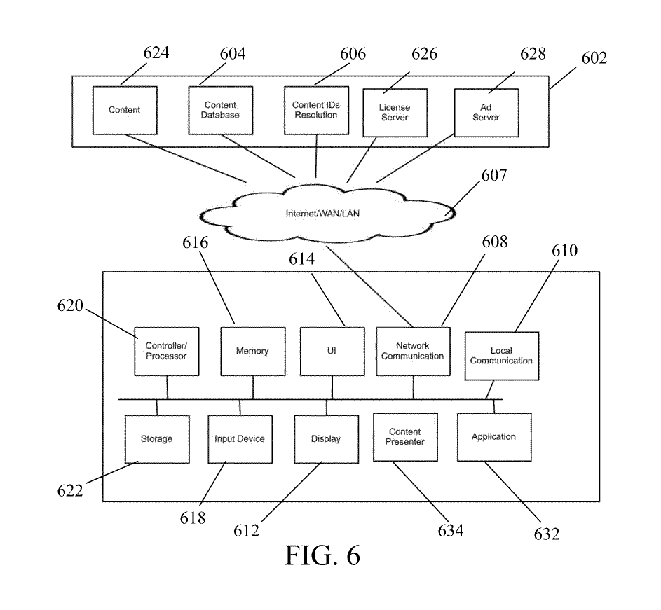

FIG. 6 is a block diagram illustrating exemplary system modules for creating and presenting content for studying, in accordance with an embodiment of the present invention. The system 600 comprises a server 602 comprising content 624, a content database 604, a content ID resolution module 606, a license server 626, and an ad server 628. The server 602 is coupled via a network such as the Internet 607 to a network communication module 608 which in turn is coupled with a local communications module 610, a display module 612, a user interface (UI) module 614, a memory module 616, an input device 618, a controller/processor 620, a secondary storage module 622, application 632 and a content presenter module 634. The server 602 stores a plurality of applications for enhancing a learning experience. The content database 604 comprises original content references for available content 624 and associated versions of the content 624, and the content ID resolution module 606 comprises content identifications (IDs) along with applications for associating each ID with content. A user is enabled to create a plurality of versions of content by using controller/processor 620, input device 618 and UI module 614. The content and associated content may be stored in the memory module 616 and the secondary storage module 622. The storage module may include but is not limited to hard disks, solid state devices (SSD), flash-based devices, tape, or portable storage mediums such as CDs, DVDs, Blu-ray discs, etc.

A Digital Rights Management system is used for the protection and distribution of the content enhanced by using the method of the present invention. A license server 626 is utilized to issue licenses for the content for a given piece of content or subset of content for a specific length of time. In an embodiment this license may be transferred to a new user by firstly causing revocation of the current user's license and then issuing a new license to the new user. Further, this license transfer may include a transaction fee or some monetary exchange. In an embodiment, content enhanced by using the present invention may be viewed in a host of multimedia display devices 612 such as computers, desktops, laptops, television monitors, multimedia display tablets, mobile devices, and cellular telephone handsets. Ads may also be delivered in conjunction with the content that is available from an ad server 628. Further, the associated input devices 618 for entering content and defining subsets comprise pen based devices, touch screens, remote controls, keyboards either physical or virtual (onscreen), mouse, etc. In an embodiment, content presentation module 634 may comprise an application programming interface (API) for application 632 running on the controller/processor 620 to interface and control the content. This interface may include a Book Viewer API comprising an application for performing functions such as: obtaining an ID for content being viewed, opening the content associated with the ID, obtaining a current page, going to the page, overlaying an image on the page, overlaying highlight on the page, obtaining text, obtaining images and an image snapshot of the text, setting rights to particular pages within the content, obtaining rights to a page within the content, etc.

An exemplary API that is provided by Google for an embedded viewer API includes application calls such as:

### Method Summary

string getPageNumber( )

Returns the page number of the page that's currently visible in the viewport.

boolean goToPage(pageNumber)

Returns true if the page exists and was turned to.

boolean is Loaded( )

Indicates whether the viewer has been successfully initialized with the given book.

highlight(opt_string)

Highlights a term in the viewport.

load(identifiers, opt_notFoundCallback, opt_successCallback)

Loads a book in the viewport.

nextPage( )

Goes to the next page in the book.

previousPage( )

Goes to the previous page in the book.

resize( )

Resizes the viewer to conform to size of its container div.

zoomIn( )

Zooms into the viewer.

zoomOut( )

Zooms out of the viewer.

The above exemplary API can be utilized by the application 632 to control the original content and, overall, the supplemental content or filters over the original content. Additionally the application 632 can add additional overlays to the display of the content for hiding and showing content.

In one embodiment, original content 624 is obtained or previously purchased by a consumer and downloaded or used over a network 608 via the controller/processor 620 and can be stored locally in storage 622. This content can be displayed using the display 612 and then interacted with using the user interface (UI) 614 and Input Device 618. This content can be used to create additional content or study material using the original content 624. This new material can be shared over local communication 610 such as Wi-Fi, Bluetooth, Near Field communications (NFC) etc. or via a network communication or the Internet back to a content repository 624 to be used by others. This newly created content can further be associated with the original content identifier through the content database 604 and content ID resolution 606. This created content can also be licensed through license server 626 along with the original material or licensed separately based on the decision of the original creator.

In an embodiment, the server 602 can be distributed with each of the respective components to be distributed across different servers and each can be run as an independent component. The server 602 receives requests over the network 607 and returns responses based on the type of request. In an embodiment, the Content IDs Resolution component 606 may be responsible for both creating content IDs at upon receiving a first request and associating them to content and upon later requests resolving the content IDs and returning references to the content from the Content Database 604. The Content Database 604 can reference content that is both local to a user's system, i.e. stored in storage 622 or content that is stored on the server 602 or in other content locations on the Internet, in which case a content uniform resource identifier (URI) is returned. The URI may be composed of a uniform resource locator (URL) and/or a uniform resource name (URN).

Hence, the present invention enhances learning and studying experience by eliminating the need for making additional notes derived from a book on paper, or making paper flash cards, or manually generating study material. Further, the digital study material created by using the method of the present invention may be shared with a plurality of users, thereby facilitating enhanced learning of the material through content by a breakdown of key items in a text book or other content, lecture or other classroom material, by multiple students for generation of the study material.

The content can be aggregated together from multiple students into a single new piece of supplemental content or study material. Several students, for example, may divide up a book into sections and each student may create study material for their respective section. This study material may then be combined to form a new project that is a study material for the entire book. In an embodiment, the created material by the individual students may also be combined for a same section. In an additional step a user may rate a sub-section of the content as a duplicate and present only the selected version or can alternate between multiple versions of the same supplemental or original content.

A presentation mode may be provided that allows for the merging of content from multiple contributors for easy selection. This merging could be different for each person collecting content from other contributors thus creating a personalized version for each person that merges the respective content differently by selecting different pieces of content to form the final set of content to be studied. This selection process may be based on predefined performance preferences, such as ratings or just a manual selection by the user. In another embodiment, the supplemental content may be rated to indicate the effectiveness of the content corresponding to the test that the user had to take based on the content. This rating could include the final test score percentage of the user. The rating system can include different ratings for users that used the material at a specific institution or school and even with a particular professor or teacher. This rating can be used by other users of later classes to select the best piece of additional content to use for a given class, subject or material that needs to be learned.

The present invention also provides that the associated material (subset of original content) that is presented for learning, comprises a link to the original content, enabling a user to view the position of the associated content within the original content from which it was derived.

The above examples are merely illustrative of the many applications of the system of present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A method for creating and presenting one or more versions of content derived from an original content source, the method comprising the steps of:
a. obtaining an original content source;
b. obtaining an identifier for the original content;
c. defining one or more subsets of the original content;
d. saving the modified subsets as different versions of content; and
e. presenting one or more of the saved modified subsets of content.

2. The method as claimed in claim 1 further comprising the steps of:
a. scoring each presentation of each version of content based on a user's performance in learning the versions of content;
b. generating a final score corresponding to one or more versions of content based on the score of each presentation;
c. re-presenting the versions of content based on the final score and the scores of each version of content; and
d. presenting trending graphics indicating the user's performance over a predetermined number of iterations and time.

3. The method as claimed in claim 1 wherein the original content comprises study material, textbooks, notes, hand-outs, published materials, and multimedia content.

4. The method as claimed in claim 1 wherein the identifier for the original content is obtained by using a hash algorithm.

5. The method as claimed in claim 1 wherein the identifier for the original content includes a location on a page or a presented item.

6. The method as claimed in claim 1 wherein a subset of the original content is defined by using filters and/or overlays.

7. The method as claimed in claim 1 wherein a subset or original content is defined by identifying a version of the original content relating to the original content.

8. The method as claimed in claim 1 wherein a subset is defined by indication a first portion of the original content and then indicating a second portion of the original content relating to the first portion.

9. The method as claimed in claim 1 wherein a subset of an original content is defined by using overlays to cover one or more portions of the original content when the original content comprises a picture, the overlays being displayed in a presentation mode, the overlays being removable by a user.

10. The method as claimed in claim 1 wherein a subset of an original content is defined by using one or more overlays to cover one or more portions of the original content, the overlays being available in a plurality of editable shapes.

11. The method as claimed in claim 1 wherein the saved versions of content are shared among a plurality of users over a network.

12. The method as claimed in claim 1 wherein presenting a version of content comprises prompting a user to provide a solution to one or more problems posed in the version of content.

13. The method as claimed in claim 1 wherein presenting a version of content comprises prompting a user to provide a solution for uncovering one or more overlaid portions of the version of content.

14. The method as claimed in claim 2 wherein scoring each presentation comprises prompting a user to indicate a success or a failure corresponding to one or more problems posed in the presented version of content, a score being obtained by summing the number of successes indicated corresponding to the version of content.

15. The method as claimed in claim 1 wherein the step of defining one or more subsets comprises prompting a user to select a predefined mode from among a plurality of available modes of displaying content.

16. The method as claimed in claim 1 wherein a user is prompted to rate each version of content, the ratings being stored.

17. The method as claimed in claim 1 wherein the step of defining a subset of the original content comprises creating one or more flashcards based on the original content, each flash card having a first side comprising a question and a second side comprising a solution to the question, the second side being revealed to a user in a presentation mode upon receiving a prompt for the same from the user.

18. The method as claimed in claim 1 wherein the step of defining a subset of the original content comprises annotating sections or pages of the original content in an order of importance.
